(19) United States
(12) Patent Application Publication
(10) Pub. No.: US 2006/0060134 A1
(43) Pub. Date: Mar. 23, 2006

(54) Turnable device for spin-coating

(76) Inventors: Tae Sik Kang, Daejeon-city (KR); Seongkeun Lee, Daejeon-city (KR); Youngjun Hong, Daejeon-city (KR)

Correspondence Address: MCKENNA LONG & ALDRIDGE LLP, 1900 K STREET, NW, WASHINGTON, DC, 20006, US

(21) Appl. No.: 11/226,338

(22) Filed: Sep. 15, 2005

(30) Foreign Application Priority Data
Sep. 21, 2004 (KR) 10-2004-0075490

(51) Int. Cl. B05C 13/02; B05C 13/00; B05C 11/02

(52) U.S. Cl. 118/52

(57) ABSTRACT

Provided is a turntable device for spin-coating a substrate having a central hole formed in the central portion thereof with an external coating material. The turntable device includes: a support unit having a flat surface with at least one vacuum hole which supply vacuum force to fixedly support the substrate thereon; an elastic body at the center of the support unit to be inserted into the central hole of the substrate, and closing the central hole by being elastically deformed due to an external force; and a pressing member disposed on the elastic body and pressing the elastic body to deform the elastic body elastically. Not having an additional element for closing the central hole of the substrate during spin-coating simplifies the apparatus and the coating process, and prevents the central portion of the substrate from being contaminated after the spin-coating.

This application claims the priority of Korean Patent Application No. 10-2004-0075490, filed on Sep. 21, 2004, in the Korean Intellectual Property Office, the disclosure of which is incorporated herein in its entirety by reference.

### BACKGROUND OF THE INVENTION

1. Field of the Invention

The present invention relates to a turntable device for spin-coating various substrates including an optical disc.

2. Description of the Related Art

Optical discs are widely used as information recording media of optical pickup apparatuses which record and reproduce information in a non-contact manner. Examples of optical discs include a compact disc (CD) with a storage capacity of 600-800 MB and a digital versatile disc (DVD) with a storage capacity of 4-10 GB. Efforts have been made to develop optical disc with higher integrity of data.

Recently, to store more data and achieve higher audio and video quality, a blue-ray disc (BD) or a high definition-digital versatile disc (HD-DVD) with a storage capacity of 20 GB or greater have been developed using 405 nm blue laser.

To increase recording density of optical discs, various methods are used. One possibility in this regard is to minimize the size of a light spot, which is achieved by controlling the wavelength of a laser and the number of apertures of a lens according to the following equations:
D∝1.22λ/NA (1)
F∝λ/NA² (2)
f∝A/2NA (3)
where D denotes the diameter of a spot, λ denotes the wavelength of a laser, NA denotes the number of apertures of a lens, f denotes a focal length, and A denotes the diameter of a lens.

As shown in Equation 1, when the wavelength of a laser decreases and the number of apertures of a lens increases, the size of a spot decreases, the pit of a disc and the size of a corresponding track decrease, and the recording density increases in inverse proportion to the value of square of the diameter of the spot.

On the other hand, as shown in Equations 2 and 3, when the wavelength decreases and the number of the apertures increases, the focal depth decreases and the focal length decreases.

That is, the BD has a light spot of a smaller diameter, smaller focal depth, and smaller focal length than the DVD, which has a light spot of smaller diameter, smaller focal depth, and smaller focal length then the CD. As the focal depth and the focal length decrease, the reproducing characteristics become more sensitive to the state of a light incidence surface of the optical disc. Accordingly, the incidence surface must be protected from scratches, and variance of the thickness of the optical disc must be very small.

Meanwhile, in a method of manufacturing an optical disc, a light-transmitting layer, a protective layer, a lacquer layer, and the like are formed by spin-coating. The use of spin-coating brings about many advantages. For example, a photocurable resin that is remained after the spin-coating can be re-circulated in the apparatus, and by controlling the time for the spin-coating and the viscosity of the resin, the light-transmitting layer can have various thicknesses.

FIG. 1 is a graph illustrating a relationship between the thickness of the light-transmitting layer and the distance between the center of a substrate and a position at which a photocurable resin is discharged onto the substrate during spin-coating.

Curve A represents the case where the distance between the center of the substrate and the position at which the photcurable resin is discharged onto the substrate is 5 mm, curve B represents the case where the distance is 10 mm, curve C represents the case where the distance is 15 mm, curve D represents the case where the distance is 20 mm, and curve E represents the case where the distance is 25 mm.

As can be seen from the graph, the position at which a photocurable resin discharged onto the substrate is closer to the center of the substrate, the variance of the thickness of the light-transmitting layer decreases. It means that when the discharge position of the resin corresponds to the central axis of the substrate, a light-transmitting layer with no thickness variance can be obtained in principle.

In a method of manufacturing a CD, because the focal distance of laser is very long, a recording layer and a reflecting layer are formed on a polycarbonate substrate with a thickness of 1.2 mm by sputtering, and then a thin lacquer layer is formed thereon by spin-coating to protect the recording layer, the reflecting layer.

Since the thickness of the lacquer layer is as small as 3 μm to 5 μm, even though a thickness variance occurs, the variance is very low. Also, a recording or reproducing light enters from the lower portion of the polycarbonate substrate such that even when the thickness of the upper most layer, that is, the lacquer layer, varies, no errors occur during data reproducing. Accordingly, there is no need to discharge the photocurable resin at the center of the optical disc when the lacquer layer is formed by spin-coating.

However, in a method of manufacturing a BD using a blue laser, the focal length is very short, the integrity of data is very high, a reflecting layer, and a recording layer, are formed on a 1.1 mm thick polycarbonate and then a 0.1 mm thick light-transmitting layer, through which a reproducing light enters, is formed thereon. Accordingly, the reproduction characteristics of the BD are very dependent on the state of the surface and the thickness variance of the light-transmitting layer.

The light-transmitting layer can be formed by attaching a 0.1 mm thick light-transmitting sheet made of polycarbonate using a reduced pressure adhesive or an ultraviolet curable adhesive. In this case, however, since a disc where the light-transmitting sheet is attached should be cut, much of the sheet is wasted, the manufacturing costs are increased, and the environment load is increased. Due to these problems, the spin-coating method is generally used for the formation of the light-transmitting layer.

As described with reference to FIG. 1, when the spin-coating is performed by discharging the photocurable resin circularly at a position departing from the center of the disc, the thickness of the resin layer increases from the center of the disc to the outside. When such an increase of the thickness occurs in the BD, data reproducing errors may occur. In order to prevent this problem, the photocurable resin must be discharged at the center of the rotating disc. However, since a disc has a hole at its center, the photocurable resin discharged at the center can leak into the hole. So, a method is required to prevent the leakage of the photocurable resin into the hole

FIG. 2 is a cross-sectional view of a conventional turntable device for spin-coating an optical disc using technology for preventing a photocurable resin from leaking into a central hole of the optical disc.

Referring to FIG. 2, a conventional turntable device for spin-coating an optical disc A includes a turntable 13 having a top surface on which the optical disc A is fixed and rotating about an axis due to an external power, and a cap 15 inserted into a central upper portion of the turntable 13 to close a central hole B of the optical disc A.

A ring-shaped disc support projection 21 projects along an outer circumference of a central portion of a top surface of the turntable 13 and supporting an inner circumference of the optical disc A, and a cap receiving space 23 is formed inside the disc support projection 21. The cap receiving space 23 accommodates a part of a bottom surface of the cap 15 and stably holds the cap 15 during rotation of the turntable 13.

A vacuum hole 19 is formed under the cap receiving space 23. The vacuum hole 19 communicates with an external vacuum pump (not shown), and provides a vacuum pressure to pull down the cap 15. Vacuum holes 17 provide a vacuum force to fix the optical disc A to the top surface of the turntable 13.

The conventional turntable device 11 has a drawback in that a photocurable resin penetrates between the cap 15 and the optical disc A. The photocurable resin leaking under the edge of the cap 15 is conglomerated and contaminates the central portion of the optical disc A. In particular, when the optical disc A is loaded on a driver, the axis of the driver may not be aligned with the central hole B of the optical disc A, thereby increasing errors.

Further, since the conventional turntable device 11 needs to mount and remove the cap before and after the photocurable resin is coated, the time for the process increases, work efficiency decreases, and manufacturing costs increase. In addition, since there is a thickness difference between a portion covered by the cap 15 and portions adjacent to the covered portion, recording and reproducing errors may occur.

### SUMMARY OF THE INVENTION

The present invention provides a turntable device for spin-coating, which does not use an additional element for covering a central hole of a substrate during spin-coating such that the device has a simple structure, the coating process is simply performed, and the central portion of the substrate is not contaminated after the spin-coating.

In accordance with an aspect of the present invention, there is provided a turntable device for spin-coating a substrate having a central hole formed in the central portion thereof with an external coating material due to a centrifugal force by rotating the substrate, the turntable device comprising: a support unit having a flat surface that has at least one vacuum hole which supply vacuum force to the substrate for fixedly supporting the substrate on the horizontal surface; an elastic body disposed at the center of the support unit to be inserted into the central hole of the substrate that is fixedly supported on the surface of the support unit, and closing the central hole by being elastically deformed due to an external force; and a pressing member disposed on the elastic body and pressing the elastic body to deform the elastic body elastically.

The elastic body may have a predetermined thickness and have an outer circumference facing an inner circumference of the central hole of the substrate.

The support unit may have a vacuum hole which passes through the support unit under the elastic body. The turntable device may further comprise a stopping rod formed on a bottom surface of the pressing member to pass through the elastic body and extend into the vacuum hole such that the stopping rod can move in the inside of the vacuum hole due to a vacuum force applied to the vacuum hole.

The vacuum hole may guide the movement of the stopping rod, and have a stepped portion formed on an inner circumference thereof to limit the movement of the stopping rod.

The elastic body may have a plurality of concavo-convex portions formed along an outer circumference thereof.

The elastic body may be selected from the group consisting of a natural rubber, an isoprene rubber, a butadiene rubber, a chloroprene rubber, a styrene-butadiene-styrene (SBS) rubber, a nitrile butadiene rubber (NBR), a styrene butadiene rubber (SBR), a silicon rubber, and a urethane rubber.

The turntable device may further comprise a discharge hole formed around the elastic body to discharge the coating material.

The turntable device may further comprise a connection rod fixed on a bottom surface of the pressing member and passing through the elastic member and the support member to extend down from the support unit, and a driving unit equipped below the support unit which downwardly moves the connection rod to cause the pressing member to elastically deform the elastic body to close the central hole.

The connection rod may be a magnetic body, and the driving unit may include an electromagnet that generates a magnetic force by an external electric signal to operate the connection rod.

The driving unit may be a hydraulic or a pneumatic actuator that is linked to the connection rod and moves the connection rod.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating a relationship between the thickness of a light-transmitting layer and a distance between the center of a substrate and a photocurable resin applied to the substrate during spin-coating;

FIG. 2 is a cross-sectional view of a conventional turntable device for spin-coating;

FIGS. 3 and 4 are cross-sectional views for explaining the construction and operating mechanism of a turntable device according to an embodiment of the present invention;

FIG. 5 is a partial cross-sectional view of a modified example of the turntable device for spin-coating of FIGS. 3 and 4;

FIG. 6 is a cross-sectional view for explaining the construction and operating mechanism of a turntable device according to another embodiment of the present invention; and

FIG. 7 is a cross-sectional view for explaining the construction and operating mechanism of a turntable device according to still another embodiment of the present invention.

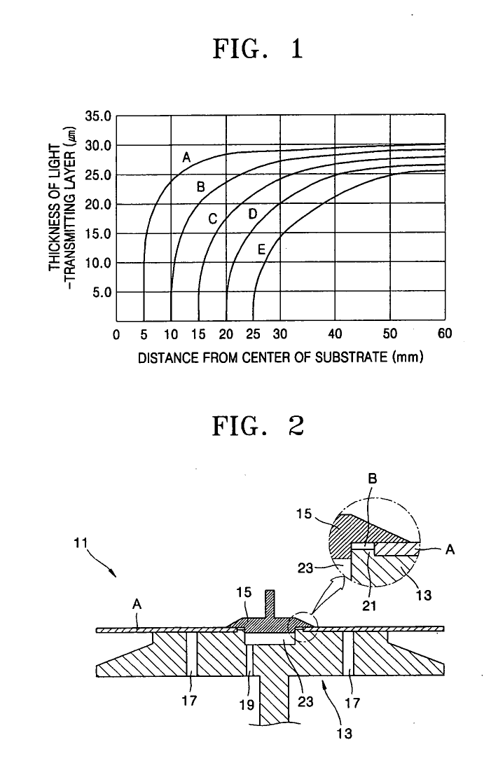

### BEST MODE FOR CARRYING OUT THE INVENTION

The present invention will now be described more fully with reference to the accompanying drawings, in which preferred embodiments of the invention are shown.

In the detailed description, an optical disc is coated among various kinds of substrates.

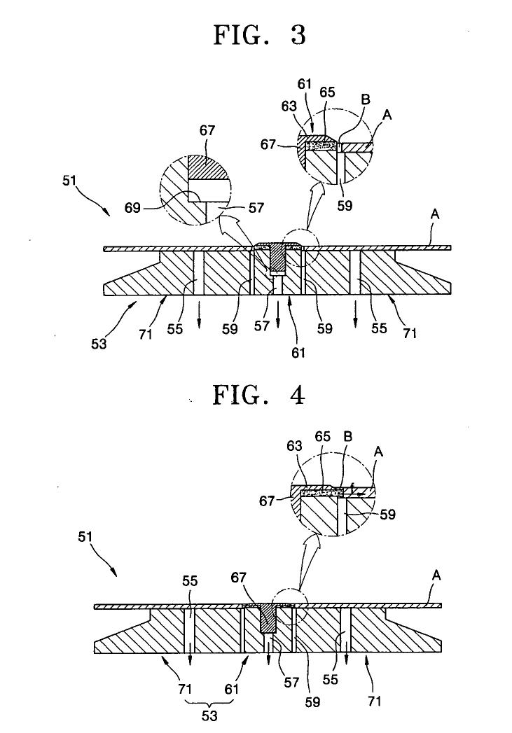

FIGS. 3 and 4 are cross-sectional views for explaining the construction and operating mechanism of a turntable device for spin-coating according to an embodiment of the present invention.

Referring to FIGS. 3 and 4, a turntable device 51 includes a turntable 53 having a flat horizontal surface to which an optical disc A is fixed, and an elastic body 65 installed on a top surface of the central portion of the turntable 53 and closing a central hole B of the fixed optical disc A by being elastically deformed due to an external force.

In detail, the turntable 53 includes a support unit 71 closely contacting a bottom surface of the optical disc A to be coated and fixing the optical disc thereto using a vacuum pressure applied to vacuum holes 55, and a fitting unit 61 disposed in a central portion of the support unit 71 and having a pressing plate 63 and the elastic body 65 formed on an upper portion thereof. Each of the elastic body 65 and the pressing plate 63 has a disc shape with a predetermined diameter, and is placed within a central hole B of the optical disc A.

The support unit 71 and the fitting unit 61 are integrally formed with each other to rotate simultaneously, and a resin discharge hole 59 is formed betweent the support unit 71 and the fitting unit 61. The resin discharge hole 59 downwardly discharges a photocurable resin that is supplied from the upper side.

The plurality of vacuum holes 55 are formed in the support unit 71. The vacuum holes 55 are connected to an external vacuum pump, and fix the optical disc A, which is mounted on the top surface of the support unit 71, to the turntable 53 using a vacuum force.

The elastic body 65 disposed on the upper portion of the fitting unit 61 has a predetermined thickness. The elastic body 65 is an elastically deformable member selected from the group consisting of a natural rubber, an isoprene rubber, a butadiene rubber, a chloroprene rubber, a styrene-butadiene-styrene (SBS) rubber, a nitrile butadiene rubber (NBR), a styrene butadiene rubber (SBR), a silicon rubber, and a urethane rubber. However, the material of the elastic body 65 can be anything commonly used in the art.

An outer circumference of the elastic body 65 faces an inner circumference of the central hole B of the optical disc A. The diameter of the elastic body 65 is equal to or less than the diameter of the central hole B.

The pressing plate 63 disposed on the upper portion of the elastic body 65 downwardly presses the elastic body 65 to expand the elastic body 65 in a radial direction. Then, the outer circumference of the elastic body 65 presses the inner circumference of the central hole B in a direction marked by arrow f, thereby completely closing a gap between the inner circumference of the central hole B and the elastic body 65.

According to the turntable device 51 of the present embodiment illustrated in FIGS. 3 and 4, since the central hole B of the optical disc A is closed by compressing the elastically deformable elastic body 65, the photocurable resin is prevented from leaking into the bottom surface of the optical disc A.

Another vacuum hole 57 is formed under the central portion of the elastic body 65. The vacuum hole 57 is connected to the external vacuum pump, and provides a vacuum pressure to pull down the pressing plate 63. A stepped portion 69 is formed on the inner circumference of the vacuum hole 57 to limit a downward movement of a stopping rod 67.

The stopping rod 67 is fixed to a bottom surface of the central portion of the pressing plate 63. The stopping rod 67 is a rod having a predetermined section that passes through the elastic body 65 and extends into the vacuum hole 57.

A lower end of the stopping rod is located over the stepped portion 69 to be caught by the stepped portion 69 when the pressing plate 63 downwardly moves, thereby limiting the downward movement of the pressing plate 63. The stopping rod 67 is designed to have a vertical length so that the heights of the optical disc A and the pressing plate 63 can be the same when the elastic body 65 closes the central hole B.

The pressing plate 63 has a predetermined thickness, and the edge of the pressing plate 63 is downwardly inclined in a radial direction. The edge of the pressing plate 63 may be inclined at various angles, and preferably a lower end of the inclined edge is as close to the edge of a top surface of the elastic body 65 as possible.

The inclined edge of the pressing plate 63 enables the optical disk A to be easily mounted on the turntable 53. That is, when the optical disc A is mounted on the turntable 53, even though the inner circumference of the central hole B is laid on the edge of the pressing plate 63, the optical disc A can be easily mounted on the support unit 71 by smoothly sliding on the inclined portion of the pressing plate.

Before an external force is applied, the height of the pressing plate 63 is greater than that of the mounted optical disc A. If the height of the pressing plate 63 is equal to or less than that of the optical disc A, the height of the pressing plate 63 becomes lower than the height of the optical disc A when the pressing plate 63 downwardly moves. In this case, bubbles may be generated in the photocurable resin during the spin-coating and the central portion of the optical disc A may be contaminated.

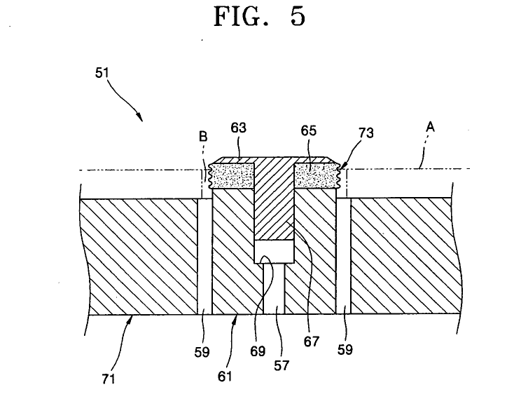

FIG. 5 is a partial cross-sectional view of a modified example of the turntable device for spin-coating of FIGS. 3 and 4.

The same elements are given the same reference numerals, and a detailed explanation thereof will not be given.

Referring to FIG. 5, concavo-convex portions 73 are formed along the outer circumference of the elastic body 65. A convex portion of the concavo-convex portions 73 closely contacts the inner circumference of the optical disc A to prevent the photocurable resin from leaking into the central hole B.

The turntable device for spin-coating according to the present embodiment can be used to manufacture a write once read many (WORM)-type optical disc, an erasable-type optical disc, which include a recording layer, a read only memory (ROM) optical disc, and any optical disc including a light-transmitting layer that is formed by spin coating. The apparatus can also be used to form, in addition to the light-transmitting layer, a protective layer, a middle layer, a lacquer layer, or the like, in order to improve the mechanical characteristics of the optical disc.

A method of spin-coating a photocurable resin using the turntable device according to an embodiment of the present invention will now be explained.

First, when the optical disc A is fixed to the upper portion of the turntable 53, a vacuum pressure is applied to the vacuum hole 57 such that the elastic body 65 can be in close contact with the inner circumference of the central hole B of the optical disc A.

The photocurable resin is discharged through a nozzle onto the central axis of the pressing plate 63, and at the same time, the turntable 53 starts to rotate. During the process of supplying the photocurable resin, the turntable 53 rotates at a rotation speed of about 20 rpm to 100 rpm, and right after the resin is completely discharged, the rotation speed of the turntable 53 is increased to form a uniform light-transmitting layer.

The rotation speed of the turntable 53 during the spin-coating is closely related to the thickness of the light-transmitting layer to be formed. As the rotation speed increases, the thickness of the light-transmitting layer decreases. The photocurable resin can be any photocurable resin that is commonly used in the art. For example, an acrylate resin may be used as the photocurable resin.

After the photocurable resin is spin-coated, the optical disc A should be removed from the turntable 53. The removal of the optical disc A from the turntable 53 can be performed before or after the photocurable resin has hardened. However, when the optical disc A is removed after the photocurable resin has hardened, a boundary surface of the light-transmitting layer may be slightly damaged such that a burr can be formed. Accordingly, preferably, the optical disc A is removed before the photocurable resin has hardened by emitting light.

To separate the optical disc A from the turntable 53, the vacuum pressure applied to the vacuum holes 55 and 57 should be removed. If the vacuum pressure applied to the central vacuum hole 57 is removed, the elastic body 65 returns to its original state and becomes spread out from the central hole B to lift the optical disc A.

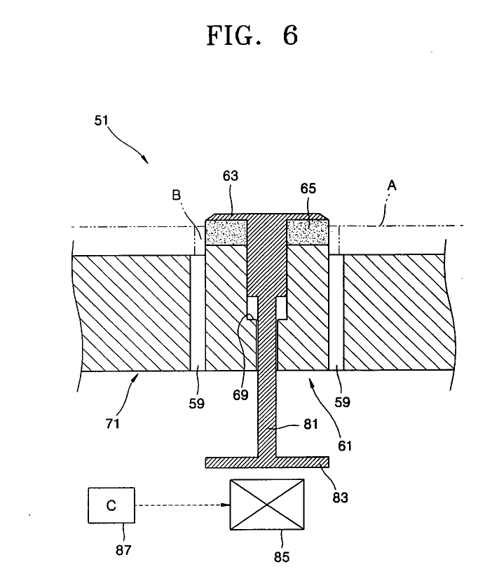

FIG. 6 is a cross-sectional view for explaining the construction and operating mechanism of a turntable device for spin-coating according to another embodiment of the present invention.

Referring to FIG. 6, a connection rod 81 is disposed under the pressing plate 63 and extends downwardly. The connection rod 81 passes through the fitting unit 61 such that a lower end of the connection rod 81 is disposed under the fitting unit 61. A driven plate 83 is disposed on a lower end of the connection rod 81.

The driven plate 83 is a disc having the same central axis as the connection rod 81, and is attached to an electromagnet 85 due to a magnetic force. To this end, the driven plate 83 is made of a magnetic material. If the pressing plate 63, the connection rod 81, and the driven plate 83 are integrally formed with one another, all the pressing plate 63, the connection rod 81, and the driven plate 83 are made of a magnetic material. Alternatively, only the driven plate 83 may be made of a magnetic material and then separately fixed to the lower end of the connection rod 81.

The electromagnet 85 is disposed under the driven plate 83. The electromagnet 85 receives an electric signal from an external controller 87 and generates a magnetic force to pull down the driven plate 83. As the driven plate 83 downwardly moves, the pressing plate 63 downwardly moves such that the elastic body 65 closes the central hole B.

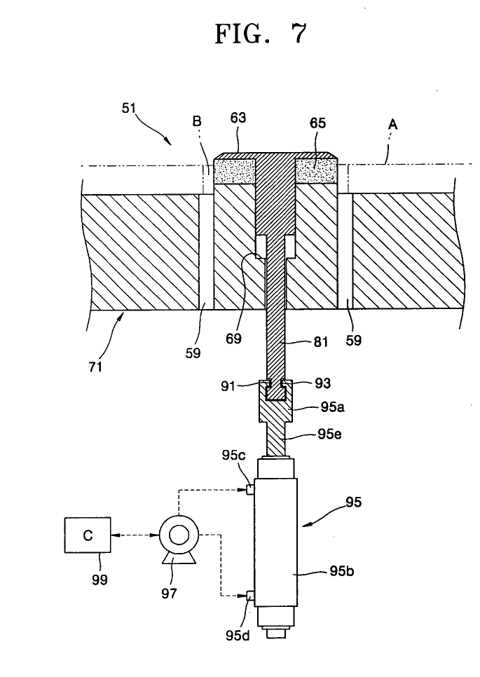

FIG. 7 is a cross-sectional view for explaining the construction and operating mechanism of a turntable device for spin-coating according to still another embodiment of the present invention.

Referring to FIG. 7, an actuator 95 is installed on the lower end of the connection rod 81. The actuator 95 is fixedly supported on a frame (not shown) and vertically moves the connection rod 81.

The actuator 95 is a well-known actuator, and includes a cylinder 95b having first and second inlets 95c and 95d, and an actuation rod 95e installed inside the cylinder 95b and linked to the connection rod 81 to reciprocate the connection rod 81 in a longitudinal direction.

A pump 97 pumps a working fluid into the cylinder 95b to vertically move the actuation rod 95e. The operation of the pump 97 is controlled by a controller 99.

A holder 95a is disposed on an upper end of the actuation rod 95e. The holder 95a may be integrally formed with the actuation rod 95e, or may be separately fixed to the actuation rod 95e. The holder 95a connects the actuation rod 95e to the connection rod 81.

The holder 95a has a cup shape, and has a jaw 91 formed along an inner circumference of an upper end thereof. A groove 93 is formed in a lower end portion of the connection rod 81. The jaw 91 is inserted into the groove 93, and actuates the connection rod 81 according to the linear movement of the actuation rod 95e. In particular, the connection rod 81 may rotate not by being coupled to the holder 95a. To this end, a bearing (not shown) may be installed between the connection rod 81 and the holder 95a.

As a result, the central hole B can be opened or closed by controlling the actuator 95 to linearly move the connection rod 81. That is, the central hole B is closed by the elastic body 65 by lowering the connection rod 81 during spin-coating, and the central hole B is opened by raising the connection rod 81.

Examples of optical discs which were really spin-coated using the turntable devices illustrated in the embodiments will be explained.

### SPIN COATING EXAMPLE 1

A polycarbonate (PC) optical disc substrate having a total thickness of 1.1 mm, an outer diameter of 120 mm, and an inner diameter (diameter of a central hole) of 15 mm was molded by injection molding. Then, a four-layer structure of Ag alloy/ZnS—SiO/SbGeTe/ZnS—SiO₂ was formed using sputtering.

Thereafter, the optical disc was fixed onto the upper portion of the turntable 53 shown in FIG. 3, and the pressing plate 63 was lowered such that the elastic body 65 completely closed the central hole B. The elastic body 65 was an SBR of 14.6 mm in diameter.

Next, a photocurable resin EB 8402 (made by SK UCB), Irgacure 184 (made by Ciba SC), or Irgacure 651 (made by Ciba SC) was discharged to the central upper portion of the optical disc when the disc rotated, and then the optical disc was removed from the turntable 53, thereby completing the manufacturing process of the optical disc. As a result, the time for coating was reduced as compared with the case where a cap 15 shown in FIG. 2 is used, the central portion of the optical disc was not contaminated, and a uniform coating layer was obtained.

### SPIN COATING EXAMPLE 2

An optical disc was manufactured in the same manner as in <Spin Coating Example 1>, except that the elastic body 65 shown in FIG. 5 was used. As a result, the coating time was reduced as compared with the case where the cap 15 shown in FIG. 2 is used, the central portion of the optical disc was not contaminated, and a uniform coating layer was obtained.

### SPIN COATING EXAMPLE 3

An optical disc was manufactured in the same manner as in <Spin Coating Example 1>, except that the motion of the pressing plate 63 was controlled by the electromagnet 85 explained with reference to FIG. 6. As a result, the coating time was reduced as compared with the case where the cap 15 shown in FIG. 2 is used, the central portion of the optical disc was not contaminated, and a uniform coating layer was obtained.

### COMPARATIVE EXAMPLE 1

A spin-coating was performed using the conventional turntable device 11 shown in FIG. 2.

The spin-coating was performed by fixing an optical disc to the turntable 13, properly positioning the cap 15, and applying a photocurable resin EB 8402 (made by SK UCB), Irgacure 184 (made by Ciba SC), or Irgacure 651 (made by Ciba SC) onto the central portion of the upper portion of the cap 15.

Subsequently, the cap 15 was removed from the turntable 13, and the optical disc was moved to an optical curing machine to be hardened, thereby completing the optical disc.

After the spin-coating, when the cap 15 is lifted, the optical disc was also lifted due to the resin leaking between the cap 15 and the optical disc, and the central portion of the optical disc was contaminated. In addition, the time for coating one optical disc using the conventional turntable device doubled the time using the turntable device of the present invention.

As described above, since the turntable device according to the present invention does not require an additional element for closing the central hole of the substrate during spin-coating, the device is simple, the coating process is simple, and the central portion of the substrate is not contaminated after the spin-coating.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A turntable device for spin-coating a substrate having a central hole formed in the central portion thereof with an external coating material due to a centrifugal force by rotating the substrate, the turntable device comprising:
a support unit having a flat surface that has at least one vacuum hole which supply vacuum force to the substrate for fixedly supporting the substrate on the horizontal surface;
an elastic body disposed at the center of the support unit to be inserted into the central hole of the substrate that is fixedly supported on the surface of the support unit, and closing the central hole by being elastically deformed due to an external force; and
a pressing member disposed on the elastic body and pressing the elastic body to deform the elastic body elastically.

2. The turntable device of claim 1, wherein the elastic body has a predetermined thickness and has an outer circumference facing an inner circumference of the central hole of the substrate.

3. The turntable device of claim 1, wherein the support unit has a vacuum hole which passes through the support unit under the elastic body, the turntable device further comprising a stopping rod formed on a bottom surface of the pressing member to pass through the elastic body and extend into the vacuum hole such that the stopping rod can move in the inside of the vacuum hole due to a vacuum force applied to the vacuum hole.

4. The turntable device of claim 3, wherein the vacuum hole guides the movement of the stopping rod, and has a stepped portion formed on an inner circumference thereof to limit the movement of the stopping rod.

5. The turntable device of claim 2, wherein the elastic body has a plurality of concavo-convex portions formed along an outer circumference thereof.

6. The turntable device of claim 1, wherein the elastic body is selected from the group consisting of a natural rubber, an isoprene rubber, a butadiene rubber, a chloroprene rubber, a styrene-butadiene-styrene (SBS) rubber, a nitrile butadiene rubber (NBR), a styrene butadiene rubber (SBR), a silicon rubber, and a urethane rubber.

7. The turntable device of claim 1, further comprising a discharge hole formed around the elastic body to discharge the coating material.

8. The turntable device of claim 1, further comprising a connection rod fixed on a bottom surface of the pressing member and passing through the elastic member and the support member to extend down from the support unit, and a driving unit equipped below the support unit which downwardly moves the connection rod to cause the pressing member to elastically deform the elastic body to close the central hole.

9. The turntable device of claim 8, wherein the connection rod is a magnetic body, and the driving unit includes an electromagnet that generates a magnetic force by an external electric signal to operate the connection rod.

10. The turntable device of claim 8, wherein the driving unit is a hydraulic or a pneumatic actuator that is linked to the connection rod and moves the connection rod.
